(19) United States
(12) Patent Application Publication
(10) Pub. No.: US 2018/0239225 A1
(43) Pub. Date: Aug. 23, 2018

(54) PROJECTION APPARATUS

(71) Applicants: HISENSE CO., LTD., QINGDAO (CN); HISENSE INTERNATIONAL CO., LTD., QINGDAO (CN); HISENSE USA CORPORATION, SUWANEE, GA (US)

(72) Inventors: QIANG ZHONG, QINGDAO (CN); LEI GUO, QINGDAO (CN)

(21) Appl. No.: 15/686,033

(22) Filed: Aug. 24, 2017

(30) Foreign Application Priority Data
Feb. 17, 2017 (CN) 201710086253.9

(51) Int. Cl. G03B 21/00; G03B 21/16; G03B 21/14; G02B 27/12

(52) U.S. Cl. CPC G03B 21/008; G02B 27/123; G03B 21/145; G03B 21/16

(57) ABSTRACT

The present application discloses a projection apparatus comprising a housing, a digital micromirror apparatus DMD disposed on an inner sidewall of the housing, a first lens disposed on the housing and a light source for supplying a light to the DMD, wherein an aperture is disposed on the housing; the light from the light source irradiates on the DMD and, when the DMD deflects to a first deflection angle, light reflected by the DMD is first light which emits through the first lens for image display; the light from the light source irradiates on the DMD and, when the DMD deflects to a second deflection angle, light reflected by the DMD is second light which emits out of the housing through the aperture; the projection apparatus further comprises an light absorber disposed in an emitting light path of the second light.

### CROSS-REFERENCE TO RELATED APPLICATIONS

This application claims priority to Chinese Patent Application No. 201710086253.9, filed with the Chinese Intellectual Property Office on Feb. 17, 2017, entitled “Projection Apparatus”, which is incorporated herein by reference in its entirety.

### FIELD OF THE TECHNOLOGY

The present application relates to a projection apparatus.

### BACKGROUND

Projection apparatuses have been commonly used as image display devices in various places, such as business centers, homes and exhibitions. At present, there are two kinds of common projection apparatuses, namely a liquid crystal projection apparatus and a digital light projecting (DLP) apparatus. The DLP apparatus has become a mainstream product among contemporary image display devices due to its high contrast, high responding speed and high reliability.

A core element of the DLP apparatus includes a main circuit board consisting of a plurality of video signal processors and a digital micromirror apparatus (DMD), where a digital micromirror unit group on the DMD is the most important display unit of the DLP apparatus.

### SUMMARY

The present application provides a projection apparatus comprising a housing, a digital micromirror device (DMD) disposed on an inner sidewall of the housing, a first lens disposed on the housing and a light source for supplying light to the DMD, wherein an aperture is disposed on the housing; the light from the light source irradiates on the DMD and, when the DMD deflects to a first deflection angle, light reflected by the DMD is first light which emits through the first lens for image display; the light from the light source irradiates on the DMD and, when the DMD deflects to a second deflection angle, light reflected by the DMD is second light which emits out of the housing through the aperture; the projection apparatus further includes a light absorber disposed in an emitting light path of the second light.

### BRIEF DESCRIPTION OF THE DRAWINGS

FIG. 1 is a structural diagram of a projection apparatus according to an embodiment of the present application;

FIG. 2 is an exploded structural diagram of FIG. 1;

FIG. 3 is a structural diagram of a projection apparatus according to another embodiment of the present application;

FIG. 4 is a structural diagram of a projection apparatus according to still another embodiment of the present application; and

FIG. 5 is a structural diagram of a projection apparatus according to yet another embodiment of the present application.

### DETAILED DESCRIPTION

In the current digital light projecting (DLP) apparatus, a digital micromirror device (DMD) is disposed within a housing. Light emitted by a light source may irradiate on the DMD. A first lens is disposed on the housing. Under the control of a processor, the DMD reflects the light emitted by the light source. If the light from the light source at a current position is required for projection display, a micro reflecting mirror of the DMD deflects to a first deflection angle (“ON” state) at the current position to reflect the light from the light source, so that light reflected by the DMD emits from the first lens, such light is called ON light, and we also refer to it as first light; if the light from the light source at the current position is not required for projection display, the micro reflecting mirror of the DMD deflects to a second deflection angle (“OFF” state) at the current position to reflect the light from the light source, so that light reflected by the DMD emits towards the housing, such light is called OFF light, and we also refer to it as second light.

When the current DLP apparatus is performing a projection operation, the second light of the DMD is directly reflected to the housing which absorbs the second light, and light energy of the second light is converted into heat energy which is conducted around through the housing itself. The material of the housing is generally metal and thus has a fast heat conduction speed. However, the DMD is disposed on an inner sidewall of the housing, the mounting position of the DMD is generally close to a region where the housing is irradiated, therefore, the heat in the region where the housing is irradiated is quickly transferred to the mounting position of the DMD, thus rising the temperature of the DMD, shortening the useful life of the DMD and having an impact on its reliability to a certain extent.

The projection apparatus provided by the present technical solution includes a housing and a DMD disposed on an inner sidewall of the housing, the housing is provided with a first lens and an aperture thereon, and light from a light source irradiates on the DMD and, when the DMD deflects to a first deflection angle, light reflected by the DMD is first light which emits through the first lens for image display; the light from the light source irradiates on the DMD and, when the DMD deflects to a second deflection angle, light reflected by the DMD is second light which emits out of the housing through the aperture; the projection apparatus further includes an light absorber disposed in an emitting light path of the second light.

When the DMD deflects to the second deflection angle (“OFF” state), the DMD will reflect the received light from the light source to a position away from the first lens to ensure that this part of light reflected by the DMD is not projected into the image. Such light is collectively referred to as the second light in the present embodiment, and accordingly, light reflected by the DMD which is normally reflected to the first lens and projected for image display is collectively referred to as the first light. The first light reflected by the DMD emits from the first lens, and the second light reflected by the DMD irradiates on the light absorber through the aperture, or irradiates to other place other than the housing through the aperture.

Since the aperture is disposed on the housing, and the light absorber is disposed on the outer side of the housing in the emitting light path of the second light, the second light reflected by the DMD irradiates on the light absorber. The light absorber is used to absorb the second light and the heat energy converted from the light energy of the second light, so as to prevent a significant temperature rise of a fixed region of the housing (eg. the region for fixing the DMD). At the same time, such a structure also solves the problem that the temperature of a portion of the DMD, which is disposed on an inner sidewall of the housing and the mounting position of which is generally close to the region where the housing is irradiated, is high, and thus increases the useful life of the DMD to a greater extent.

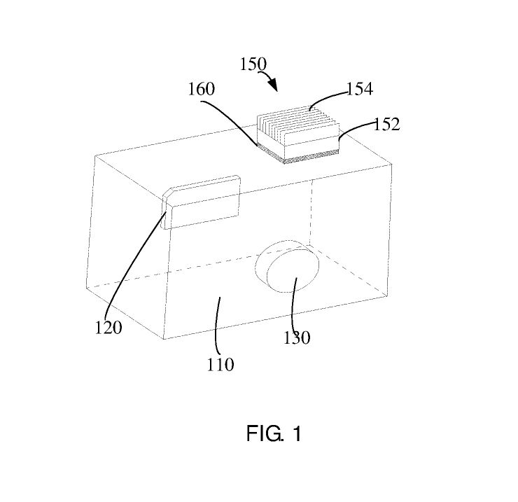

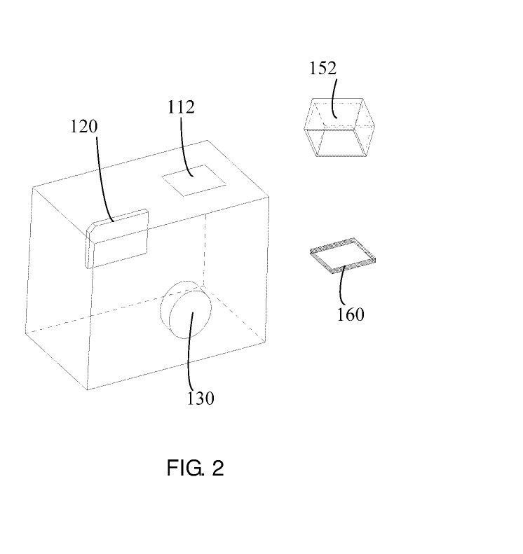

With reference to FIG. 1 and in conjunction with FIG. 2, in some embodiments, a projection apparatus includes a housing 110, a DMD 120 disposed on an inner sidewall of the housing 110, a first lens 130 disposed on the housing 110, an aperture 112 disposed on the housing 110 and a light absorber 150 disposed at a position of the aperture 112 in an outer side of the housing 110.

The first lens 130 is disposed on the housing 110. That is, the housing 110 has a first through hole thereon. The first lens 130 is embedded in the first through hole. The sidewall where the first lens 130 is located is opposed to the inner sidewall where the DMD 120 is located. The aperture 112 is disposed on a sidewall adjacent to the inner sidewall where the DMD 120 is located. First light reflected by the DMD 120 emits from the first lens 130 for image display. Second light reflected by the DMD 120 irradiates on a surface of the light absorber 150 facing the inner sidewall of the housing 110 through the aperture 112, and the second light is absorbed by the light absorber 150.

In some embodiments, an area of the aperture 112 is dependent on the area of a region where the second light irradiates. The area of the aperture 112 is slightly larger than the area of the region where the second light irradiates, so as to ensure that the second light reflected by the DMD 120 may pass through the aperture 112 and irradiate on the light absorber 150.

In some embodiments, the light absorber 150 includes an absorbing seat 152 disposed at the position of the aperture 112 on the outer side of the housing 110 and heat radiating fins 154 disposed on an outer surface of the absorbing seat 152. A first surface of the light absorber 150 faces the aperture 112 of the housing 110, and the heat radiating fins 154 are disposed on a second surface of the light absorber 150 opposite to the first surface. In some embodiments, the second surface is a surface of the light absorber 150 other than the first surface and the surface opposite to the first surface.

With reference to FIG. 2, the first surface of the absorbing seat 152 is provided with a groove thereon to form an absorbing cavity. An inner sidewall of the groove is provided with a rough layer. That is, the rugged rough layer covers the inner surface of the absorbing cavity. In addition, a fiber-assisted structure may be disposed on the inner sidewall of the groove to increase the absorption of the groove with respect to the light. The fiber-assisted structure may be a screen mesh, a screen mesh structure, a thread-like fiber, a flocculent fiber, etc. The fiber-assisted structure is disposed on the rough layer to increase the number of reflections for the second light in the groove. In some embodiments, the inner sidewall of the groove of the absorbing seat 152 is provided with a light absorbing layer for absorbing the second light that irradiates into the groove. Of course, the color of the light absorbing layer includes, but is not limited to, black, as long as it can absorb the second light.

In some embodiments, the first surface of the absorbing seat 152 facing the housing 110 is provided with the groove thereon, and an aperture of the groove is perpendicular to a surface of the housing 110 at the position of the aperture 112. The inner sidewall of the housing 110 where the DMD 120 is located is adjacent to the sidewall of the housing 110 where the aperture 112 is located, so that the second light obliquely irradiates into the groove and thus experiences many times of reflections inside the groove. Therefore, a rough layer may be disposed on the surface inside the groove, and a fiber-assisted structure may be disposed on an inner surface of the sidewall of the groove. The fiber-assisted structure has a screen mesh, so that the light may irradiate on the inner sidewall of the groove, and the fiber-assisted structure disposed on the inner sidewall of the groove may also reflect the second light irradiating on a fiber. The disposition of the fiber-assisted structure may increase the number of reflections of the second light in the absorbing seat 152, increase the absorbing rate of the second light, reduce the probability that the second light is reflected back into an interior of the housing 110 and reduce the interference to a normal optical path. Here, the screen mesh or the rough layer may be replaced with other structures as long as they can increase the number of reflections of the second light in the groove of the absorbing seat 152 and increase the absorbing rate of the second light.

In some embodiments, the region on the first surface of the absorbing seat 152 other than the groove is fixed on the outer side of the housing 110, and the aperture of the groove directly faces the aperture 112 of the housing 110.

An outer surface of the absorbing 152 is provided with the heat radiating fins 154 for heat radiation, and the outer surface provided with the heat radiating fins 154 may be a surface of the absorbing 152 other than the first surface. The heat radiating fins 154 may include multiple pieces, and the adjacent heat radiating fins 154 are parallel to each other. The material of each heat radiating fin 154 is a metal (aluminum alloy, copper, etc.) with a high heat conductivity, so that the heat energy converted by the absorbing seat 152 can be quickly emitted into the outside air.

A heat insulating structure is disposed between the absorbing seat 152 and the housing 110. Here, the heat insulating structure is a heat insulating gasket 160 disposed at an edge of the aperture 112. The heat insulating structure can also be rubber gasket or plastic gasket.

When the device is in operation, the second light reflected by the DMD 120 passes through the aperture 112 of the housing 110 and directly irradiates into the interior of the groove of the absorbing seat 152, so that the temperature of the absorbing seat 152 itself rises and the absorbing seat 152 may quickly transfer the heat to an external space through the heat radiating fins 154 or to the housing 100 connecting with it. However, the heat insulating gasket 160 is added between the absorbing seat 152 and the housing 110, thus increasing a heat transferring resistance between the absorbing seat 152 and the housing 110, rendering it difficult for the heat to be transferred from the absorbing seat 152 to the housing 110, thereby preventing an excessive temperature of the DMD 120 caused by an excessive local temperature of the housing 110 or an uneven temperature of various parts of the DMD 120, which may result in a damage on the performance or useful life of the DMD 120.

In other embodiments, a heat insulating adhesive may also be used. Of course, it is to be understood that the heat insulating structure is not limited to the heat insulating gasket 160 or the heat insulating adhesive. Other heat insulating structures may also be used as long as they can obstruct the heat from being transferred from the absorbing seat 152 to the housing 110.

In addition, a heat radiating base (not shown) may be disposed between the heat radiating fins 154 and the absorbing seat 152 for supporting the heat radiating fins 154 and simultaneously enhancing the structural strength of the heat radiating fins 154. In addition, in other embodiments, the heat radiating base is provided with a position structure, such as a hole, but not limited thereto. In addition, a connecting element (not shown), for example, a screw, may be provided to fixedly connect the heat radiating base with the housing 110, which not only enhances the structural strength of the heat radiating fins 154 and the heat radiating base, but also is advantageous for the heat radiating fins 154 to be fixedly connected and increases applicabilities and conveniences in terms of its setting.

In addition, a structure for positioning or fixing, such as a hole, but not limited thereto, may be added between the absorbing seat 152 and the housing 110. In addition, a connecting element (not shown), for example, a screw, may be provided to fixedly connect the absorbing seat 152 with the housing 110 of the projection apparatus, which, in addition to enhancing the structural strength of the absorbing seat 152 and the housing 110, is advantageous for the absorbing seat 152 to be fixedly connected, and increases applicabilities and conveniences in terms of its setting.

In addition, in some embodiments, the material of the absorbing seat 152 is a material (plastic, ceramic, rubber, etc.) with a low heat conductivity and light fastness, and being resistant to high temperatures. In this way, the heat may be first stored within the absorbing seat 152 and obstructed from being transferred outwardly or toward the housing 110.

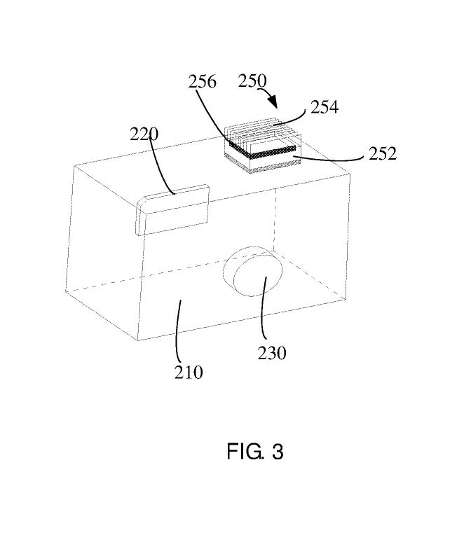

With reference to FIG. 3, in some embodiments, a projection apparatus includes a housing 210, a DMD 220 disposed on an inner sidewall of the housing, a first lens 230 disposed on the housing 210, an aperture disposed on the housing 210 and a light absorber 250 disposed at a position of the aperture in an outer side of the housing 210.

The DMD 220 is disposed on the inner surface of the housing 210. The first lens 230 is disposed on the housing 210. First light reflected by the DMD 220 emits from the first lens 230. Second light reflected by the DMD 220 irradiates on the light absorber 250 through the aperture.

The light absorber 250 includes an absorbing seat 252 and heat radiating fins 254. A first surface of the absorbing seat 252 faces the housing 210, and a second surface of the absorbing seat 252 is disposed opposite to the first surface, the heat radiating fins 254 are disposed on the second surface of the absorbing seat 252, and a heat insulating gasket is disposed between the first surface of the absorbing seat 252 and the housing 210. The structure and the connection relationship in the present embodiment are similar to those in the above-mentioned embodiment, and will not be described herein again. Similarly, internal structures, such as a rough layer, a light absorbing layer, etc, disposed within the absorbing seat 252 are the same as those in the above-mentioned embodiment, and will not be described herein again.

The first surface of the absorbing seat 252 is also provided with a groove, and a heat insulating spacer 256 is disposed on the inner sidewall of the groove. The heat insulating spacer 256 may be black. The second light directly irradiates on the heat insulating spacer 256, and the temperature of the heat insulating spacer 256 gradually rises. Since the heat resistance of the heat insulating spacer 256 per se is large, the rate of heat transferring to the absorbing seat 252 may be mitigated, and thereby the rate of temperature rise of the absorbing seat 252 per se may be mitigated. And, due to the heat insulating spacer 256 added between the absorbing seat 252 and the housing 210, the heat transferring resistance between the absorbing seat 252 and the housing 110 is increased, thus rendering it difficult for the heat transferred to the absorbing seat 252 through the heat insulating spacer 256 to be transferred from the absorbing seat 252 to the housing 210, but to be quickly emitted to the external space. That is, the heat insulating spacer 256 serves to absorb heat and buffer the heat transferring. In other words, the heat insulating spacer 256 will not cause the temperature of the absorbing seat 252 to suddenly rise while it absorbs the second light.

In some embodiments, the heat insulating spacer and the rough layer are disposed at the same time. Then, the heat insulating spacer is located between the rough layer and an inner sidewall of the absorbing seat. The heat insulating spacer in the present embodiment and the light absorbing layer in the above-mentioned embodiment are disposed at the same time. Then, the heat insulating spacer is located between the light absorbing layer and the inner sidewall of the absorbing seat.

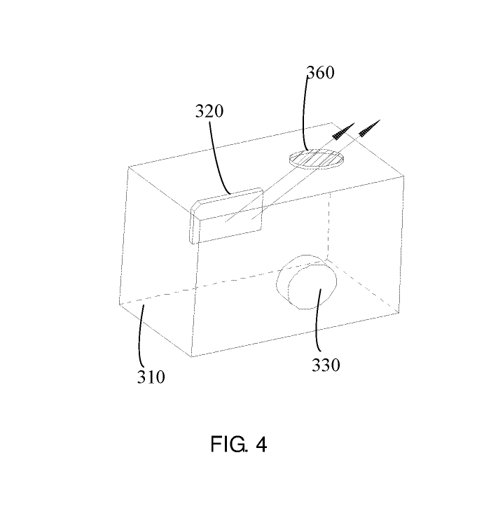

With reference to FIG. 4, in some embodiments, a projection apparatus includes a housing 310, a DMD 220 disposed on an inner sidewall of the housing 310, a first lens 230 disposed on the housing 310, an aperture disposed on the housing 310, a second lens 360 disposed at a position of the aperture on an outer side of the housing 310 and an absorbing seat disposed in an emitting light path of a second light transmitted from the second lens 360, the second lens and the absorbing seat together constitute a light absorber.

The second lens is disposed between the housing 310 and a first surface of the absorbing seat, the first surface is provided with a groove thereon, and the second light transmitted from the second lens 360 emits into the groove. To be specific, the second lens 360 may be fixed on the outer side of the housing 310 at the aperture, an aperture of the groove is disposed opposite to the aperture of the housing 310, and, other regions of the first surface of the absorbing seat other than the groove are fixed to the housing 310. A heat insulating gasket may be disposed between the housing 310 and the absorbing seat, so as to reduce the heat conduction from the absorbing seat to the housing. In other embodiments, the absorbing seat and the housing 310 may be disposed separately.

The second lens 360 has a high transmittance and a low reflectivity for the second light. The higher the transmittance of the second lens 360 is, the more the light is transmitted, and the less the light reflected on a surface of the second lens facing the interior of the housing 310 is when the second light emits from the interior of the housing 310.

The second lens 360 may be a dichroic lens, which has a high transmittance for the second light in a direction from the inner side of the housing 310 to the outer side of the housing and a lower transmittance for the second light in the opposite direction. That is, the transmittance of the dichroic lens for the second light in the direction from inside of the housing 310 toward outside of the housing 310 is greater than the transmittance of the dichroic lens for the second light in the direction from the outside of the housing 310 toward the inside of the housing 310. Therefore, it is difficult for the light to return to the interior of the housing 310 after it emits from the housing 310, thus reducing the temperature rise of the housing 310.

In some embodiments, the absorbing seat and heat radiating fins are disposed in an emitting light path of the second lens 360, and the absorbing seat may absorb the second light emitted from the housing. The absorbing seat may be provided with a groove on the surface facing the housing, and an inner wall of the groove may be provided with an inner structure, such as a rough layer, a light absorbing layer, etc.

The second lens 360 is disposed directly at the aperture of the housing 310, so that the second light may pass through the second lens 360 and irradiate to the outside of the housing 310, and thus preventing the temperature rise of the housing 310 caused by the second light.

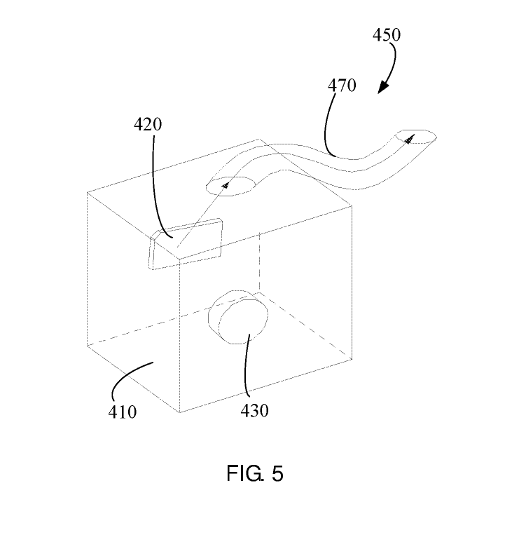

With reference to FIG. 5, in some embodiments, a projection apparatus includes a housing 410, a DMD 420 disposed on an inner sidewall of the housing 410, a first lens 430 disposed on the housing, an aperture disposed on the housing and a light absorber 450. The light absorber 450 includes a light guide structure 470 and an absorbing seat. One end of the light guide structure 470 is disposed at a position of the aperture, and the absorbing seat is disposed at the other end of the light guide structure 470. The light guide structure 470 transfers a second light emitted from the aperture to the absorbing seat.

The DMD 420 is disposed inside the housing 410. The first lens 430 is disposed on the housing 410. First light reflected by the DMD 420 emits from the first lens 430. The second light reflected by the DMD 420 irradiates on the light guide structure 470 through the aperture. One end of the light guide structure 470 receives the second light emitted from the aperture and transfers the second light, and the second light emits from the other end of the light guide structure 470 toward the absorbing seat which absorbs the energy of the second light. Thereby preventing the temperature rise caused by the direct irradiation of the second light on the housing 410.

A surface of the absorbing seat facing the light guide structure 470 is a first surface of the absorbing seat. The first surface of the absorbing seat is provided with a groove thereon. The groove may receive the second light emitted from the light guide structure 470 and absorb the second light. The other surfaces of the absorbing seat are provided with heat radiating fins thereon. The absorbing seat and the housing 410 are provided with the light guide structure 470 therebetween, so that they are disposed separately and do not contact with each other directly. This structure may enable the heat generated by the absorbing seat after it absorbs the second light to be difficult to be transferred to the housing 410, and reduce the possibility of the temperature rise of the housing 410.

The light guide structure 470 used herein may be a light guide post or an optical fiber.

Of course, it is to be understood that the light guide structure 470 is not limited to the optical fiber and the light guide post. Light guide structures in other forms may also be used as long as they can guide the OFF light out of the housing 410 in the first place.

In some embodiments, a light source may be located within the same housing as the DMD, and be disposed on an inner sidewall of the housing. Alternatively, the light source may be located outside the housing and have a separate protective housing. A through hole is disposed between the protective housing and the above-mentioned housing, and the light from the light source may pass through the through hole and irradiate on the DMD 420.

The above embodiments are only the preferred and practicable embodiments of the present application and are not intended to limit the scope of the present application. All the equivalent structural changes made based on the specification and the accompanying drawings of the present application are included within the scope of the present application.

1. A projection apparatus, comprising a housing, a digital micromirror device (DMD) disposed on an inner sidewall of the housing, a first lens disposed on the housing and a light source for supplying light to the DMD, wherein an aperture is disposed on the housing; the light from the light source irradiates on the DMD and, when the DMD deflects to a first deflection angle, light reflected by the DMD is first light which emits through the first lens for image display; the light from the light source irradiates on the DMD and, when the DMD deflects to a second deflection angle, light reflected by the DMD is second light which emits out of the housing through the aperture; the projection apparatus further comprises a light absorber disposed in an emitting light path of the second light; wherein the light absorber comprises an absorbing seat provided with a groove in a first surface thereof.

2. The projection apparatus according to claim 1, wherein absorbing seat is disposed at a position of the aperture on an outer side of the housing, and a heat insulating structure is disposed between the absorbing seat and the housing.

3. (canceled)

4. The projection apparatus according to claim 1, wherein the inner sidewall of the groove is provided with a rough layer.

5. The projection apparatus according to claim 1, wherein the inner sidewall of the groove is provided with a light absorbing layer for absorbing the second light.

6. The projection apparatus according to claim 1, wherein the inner sidewall of the groove is provided with a heat insulating spacer.

7. The projection apparatus according to claim 2, wherein a heat radiating fin is disposed on a second surface of the light absorber, and the second surface is a surface of the light absorber other than the first surface.

8. A projection apparatus, comprising a housing, a digital micromirror device (DMD) disposed on an inner sidewall of the housing, a first lens disposed on the housing and a light source for supplying light to the DMD, wherein an aperture is disposed on the housing; the light from the light source irradiates on the DMD and, when the DMD deflects to a first deflection angle, light reflected by the DMD is first light which emits through the first lens for image display; the light from the light source irradiates on the DMD and, when the DMD deflects to a second deflection angle, light reflected by the DMD is second light which emits out of the housing through the aperture; the projection apparatus further comprises a light absorber disposed in an emitting light path of the second light; wherein the light absorber comprises a second lens disposed at a position of the aperture and an absorbing seat provided with a groove in a first surface thereof and disposed in an emitting light path of the second light transmitted from the second lens.

9. The projection apparatus according to claim 8, wherein the second lens is disposed between the housing and the first surface of the absorbing seat, and the second light transmitted from the second lens emits into the groove.

10. The projection apparatus according to claim 8, wherein the first surface of the absorbing seat faces the housing, and area of the first surface other than the groove is fixed to the housing.

11. The projection apparatus according to claim 10, wherein a heat insulating structure is disposed between the absorbing seat and the housing.

12. The projection apparatus according to claim 8, wherein the absorbing seat and the housing is disposed separately.

13. The projection apparatus according to claim 8, wherein the second lens is a dichroic lens, a transmittance of the dichroic lens for the second light in a direction from inside of the housing toward outside of the housing is greater than the transmittance of the dichroic lens for the second light in the direction from the outside of the housing toward the inside of the housing.

14. A projection apparatus, comprising a housing, a digital micromirror device (DMD) disposed on an inner sidewall of the housing, a first lens disposed on the housing and a light source for supplying light to the DMD, wherein an aperture is disposed on the housing; the light from the light source irradiates on the DMD and, when the DMD deflects to a first deflection angle, light reflected by the DMD is first light which emits through the first lens for image display; the light from the light source irradiates on the DMD and, when the DMD deflects to a second deflection angle, light reflected by the DMD is second light which emits out of the housing through the aperture; the projection apparatus further comprises a light absorber disposed in an emitting light path of the second light; wherein the light absorber comprises a light guide structure and an absorbing seat provided with a groove in a first surface thereof, one end of the light guide structure is disposed at a position of the aperture, and the absorbing seat is disposed at the other end of the light guide structure, and the light guide structure transfers the second light emitted from the aperture to the absorbing seat.

15. The projection apparatus according to claim 14, wherein a surface of the absorbing seat facing the light guide structure is the first surface of the absorbing seat, and the second light transferred by the light guide structure emits from the other end of the light guide structure toward the groove.

16. The projection apparatus according to claim 14, wherein the absorbing seat and the housing is disposed separately.

17. The projection apparatus according to claim 14, wherein the light guide structure is an optical fiber or a light guide post.

18. The projection apparatus according to claim 1, wherein the light source is located within the housing.

19. The projection apparatus according to claim 1, wherein the light source is located outside the housing and has a separate protective housing, a through hole is disposed between the protective housing and the housing, and the light from the light source passes through the through hole and irradiates on the DMD.

20. The projection apparatus according to claim 1, wherein the inner sidewall of the groove is provided with a fiber-assisted structure.

21. The projection apparatus according to claim 7, wherein a heat radiating base is disposed between the heat radiating fins and the absorbing seat.
